(19) United States
(12) Patent Application Publication
(10) Pub. No.: US 2004/0080768 A1
(43) Pub. Date: Apr. 29, 2004

(54) Data distribution services

(76) Inventor: Brad R. Larson, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/282,597

(22) Filed: Oct. 29, 2002

(51) Int. Cl. G06F 15/00; G06F 3/12

(52) U.S. Cl. 358/1.13; 358/1.15

(57) ABSTRACT

A data distribution device facilitates the distribution of digital data from a variety of data source devices across a data network. The data distribution device is adapted to receive data from one or more external data source devices, process the received data in response to a predefined set of processing instructions and selectively send the processed data to a predefined set of destination addresses.

### FIELD OF THE INVENTION

The present invention relates generally to data distribution services.

### BACKGROUND

Data distribution devices, often referred to as digital sending devices, are communication devices that convert printed material, e.g., paper documents, into digital data to be automatically sent to various predefined destinations, e.g., electronic mail (email) addresses, facsimile (fax) destinations (e.g., via LAN fax, Internet fax, etc.), network printers, personal computers, or other data receiving devices. Digital sending devices normally include a scanner for scanning in the printed material and converting the printed material into digital data. Digital sending devices also generally include software or firmware for processing the digital data, such as packaging the digital data into various document formats, e.g., Portable Document Format (PDF), Tag Image File Format (TIFF), decomposing color to black-and-white, and compressing the digital data, for sending the digital data to the various predefined destination addresses. Some other forms of processing may include decomposing image elements into text, graphics, vectors, photos, polygons, etc.; running Optical Character Recognition (OCR) routines on the text elements; and running various forms of image enhancement algorithms on elements of the image, such as red-eye removal, contrast adjustment, sharpness, smoothing, or other filters or modifications.

One problem with many digital sending devices is that they accept input only in the form of printed material. Moreover, most digital sending devices have high-end scanners and elaborate paper handling mechanisms that drive up their cost and that are not required by every user. Therefore, users often pay for additional features that they do not need, or they avoid buying digital sending devices altogether.

For the reasons stated above, and for other reasons stated below that will become apparent to those skilled in the art upon reading and understanding the present specification, there is a need in the art for alternatives to existing digital sending devices to better provide digital sending services in a variety of environments.

### SUMMARY

The above-mentioned problems with digital sending devices and other problems are addressed by embodiments of the present invention and will be understood by reading and studying the following specification. The various embodiments described herein facilitate digital sending, or data distribution, services in a variety of network environments. By utilizing the data generation resources of a network in conjunction with various embodiments of the invention, digital sending services may be provided to the users of the network without the cost and limitations of a dedicated digital sending device.

For one embodiment, the invention provides a data distribution device. The data distribution device is connectable to a data network for communication with each of a plurality of data source devices. The data distribution device is adapted to receive data from one or more of the plurality of external data source devices, process the data, and selectively send the processed data to a predefined set of destination addresses on the data network. The data distribution device is adapted to process the data in response to a predefined set of processing instructions. The predefined set of processing instructions may be a set of instructions associated with a device receiving the data, a set of instructions associated with the device sending the data or a set of instructions associated with the data. The predefined set of destination addresses may be one or more destination addresses associated with the device receiving the data, one or more destination addresses associated with the device sending the data or one or more destination addresses associated with the data.

For another embodiment, the invention provides a method of distributing data in a data network. The method includes receiving data from an external data source device and processing the data in response to a predefined set of processing instructions. The predefined set of processing instructions may be a set of instructions associated with a device receiving the data, a set of instructions associated with the device sending the data or a set of instructions associated with the data. The method further includes selectively sending the processed data to a predefined set of destination addresses on the data network. The predefined set of destination addresses may be one or more destination addresses associated with the device receiving the data, one or more destination addresses associated with the device sending the data or one or more destination addresses associated with the data.

Further embodiments of the invention include methods and apparatus of varying scope.

### DESCRIPTION OF THE DRAWINGS

FIG. 1 is a block diagram of a data distribution device in accordance with an embodiment of the invention.

FIG. 2 is a block schematic of a data distribution system in accordance with an embodiment of the invention.

FIG. 3 is a functional schematic of another data distribution system in accordance with an embodiment of the invention.

FIG. 4 is a flowchart of a method of distributing data in accordance with an embodiment of the invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

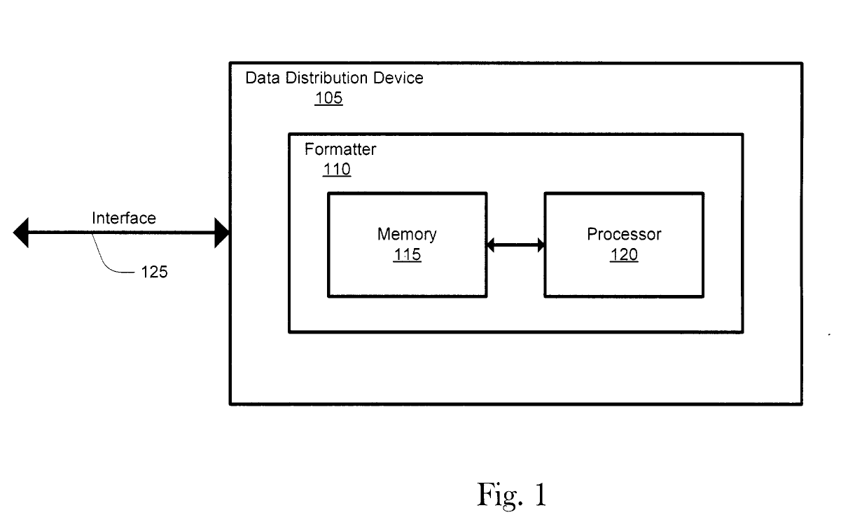

FIG. 1 is a block diagram of a data distribution device 105 in accordance with an embodiment of the invention. Data distribution device 105 includes a formatter 110 adapted to receive data, such as image data, audio data, video data, or other data structures, from a data source that is external to data distribution device 105, e.g., a scanner, digital camera, personal data assistant, electronic whiteboard, personal computer, or other data input device, via an interface 125. Formatter 110 is also adapted to format the data received from the external data source into a formatted data file, e.g., Moving Pictures Experts Group (MPEG), Portable Document Format (PDF), Tag Image File Format (TIFF), Joint Photographic Experts Group (JPEG), or other data format. Formatter 110 is adapted to transmit the formatted data file via interface 125 to one or more destination addresses, such as addresses of network devices (printers, servers, workstations, etc.), electronic messaging addresses (e.g., email, instant messaging, voicemail, video mail or other forms of electronic communication), facsimile (fax) numbers, etc., on a data network, such as a Local Area Network, the Internet, or the like.

For one embodiment, interface 125 is a network adaptor (or network interface card). Data distribution device 105 communicates with the external data source using a communication protocol, such as the JetSend® open-standard communication protocol available from the Hewlett-Packard Company, Palo Alto, Calif., USA, or other communication protocol for routing data across a network. For a further embodiment, interface 125 provides a wireless communication link between the external data source and data distribution device 105. Some examples of wireless communication links include the Infrared Data Association (IrDA) protocol; the Bluetooth™ protocol; the Institute of Electrical and Electronics Engineers, Inc. (IEEE) Standards 802.11, 802.11a and 802.11b; and the Ultra Wide Band (UVB) protocol.

For one embodiment, formatter 110 includes a memory 115, i.e., a computer-usable storage media that can be fixedly or removably attached to data distribution device 105. Some examples of computer-usable media include static or dynamic random access memory (SRAM or DRAM), read-only memory (ROM), electrically-erasable programmable ROM (EEPROM or flash memory), magnetic media and optical media, whether permanent or removable. The memory 115 may include more than one type of computer-usable media for storage of differing information types. In various embodiments, memory 115 stores the data received from the external data source for subsequent formatting by formatter 110. In one embodiment, memory 115 stores the formatted data file prior to transmission of the formatted data files to the one or more destination addresses on the data network.

For another embodiment, memory 115 contains computer-readable instructions, e.g., drivers, adapted to cause the processor 120 of formatter 110 to process the data received from the external data source into the formatted data files. Examples of processing include converting the received data from an input format to a differing output format, compressing the data, and attaching the data to a carrier. For one embodiment, processing the data includes conversion of the received data from data of one format to data of another format, even where those formats are of the same type. For example, image data may be received from a source device in JPEG format and converted by the distribution device 105 into a PDF format. Some further examples of processing may include decomposing image elements into text, graphics, vectors, photos, polygons, etc.; running Optical Character Recognition (OCR) routines on the text elements; and running various forms of image enhancement algorithms on elements of the image, such as red-eye removal, contrast adjustment, sharpness, smoothing, or other filters or modifications.

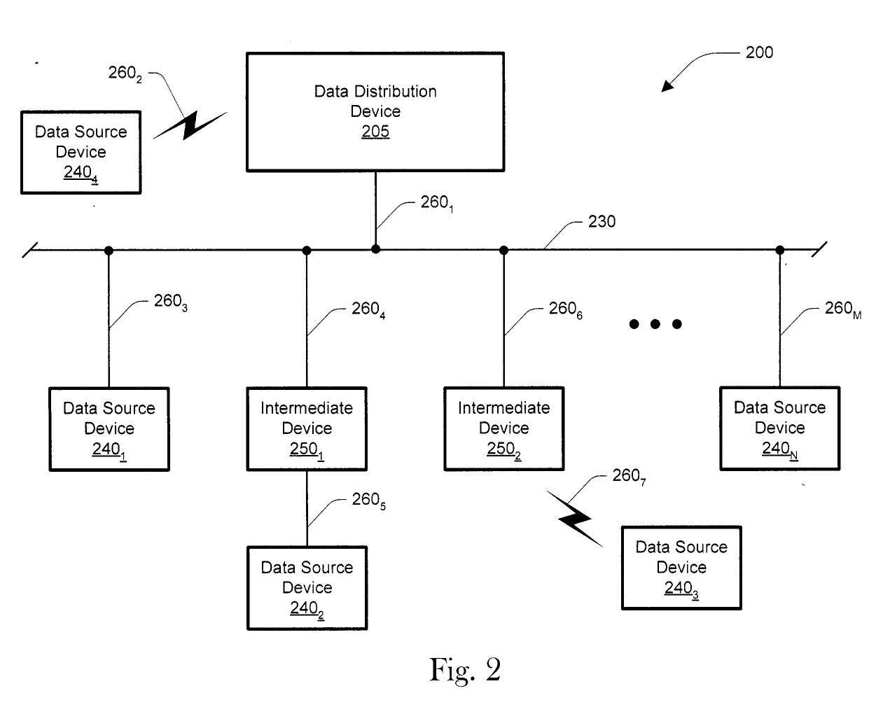

FIG. 2 is a block schematic of a data distribution system 200 in accordance with an embodiment of the invention. The data distribution system 200 includes a data network 230, a data distribution device 205 in accordance with an embodiment of the invention, and one or more data source devices 240. The data source devices 240 may be communicatively coupled to the data distribution device 205 directly, such as the direct communication link 260₂ between data source device 240₄ and data distribution device 205, or through the network 230.

Data distribution device 205 is adapted to receive and/or send data across the network 230 through a communication link 260₁. While communication link 260₁ is depicted as a hard-wired link, it could also include a wireless link.

Individual network devices may communicate with the network 230 through one or more intermediate devices, such as servers, personal computers, terminals, routers, switches, etc. As an example, data source device 240₂ is coupled to an intermediate device 250₁ through a communication link 260₅ while the intermediate device 250₁ is coupled to the network 230 through a communication link 260₄. Similarly, data source device 240₃ is coupled to an intermediate device 250₂ through a wireless communication link 260₇ while the intermediate device 250₂ is coupled to the network 230 through a communication link 260₆. Examples of external data source devices 240₁ to 240_{N} include scanners, digital cameras, personal data assistants, electronic whiteboards, personal computers, or the like.

As alluded to, the communication links 260₁ to 260_{M} may include hard-wired links, wireless links or some combination thereof. They may include direct and indirect connections between the data distribution device 205 and one or more of the data source devices 240₁ to 240_{N}. Each communication link 260₁ to 260_{M} may also represent a number of connections through a network, including passing through another device, such as a network server or router. Examples of communication links 260₁ to 260_{M} include one or more of a parallel communication link, a serial communication link, a Universal Serial Bus (USB) connection, an IR (infrared) communication link and other such wired and wireless communication links. These communication links are typically adapted for bi-directional communications.

Data distribution device 205 receives data from one or more of external data sources 240₁ to 240_{N}. Data distribution device 205 formats the data into a formatted data file and transmits the formatted data file to one or more destination addresses on a data network. For one embodiment, the output format is predetermined in response to the input format. For example, if the format of the received data is bitmap format, the output format may be predetermined to be a compressed JPEG format. For another embodiment, the output format is predetermined in response to the input data source device. For example, if the external source device 240 from which the data distribution device 205 is receiving data is a scanner, the output format may be predetermined to be a PDF format. For yet another embodiment, the output format is predetermined in response to an instruction associated with the data. For example, an instruction may be sent with the data adapted to cause the processor of the data distribution device to format the data in a format defined by the instruction.

For embodiments where the output format and/or destination addressed are determined in response to an instruction associated with the data, one or more of the external data sources 240₁ to 240_{N} is adapted for selecting the format into which to format the data, e.g., MPEG, PDF, TIFF, JPEG and/or for selecting the destination addresses to which the formatted data will be sent. Alternatively, an intermediate device 250 may act as a controller for it associated one or more data sources 240, providing instruction to the data distribution device 205 regarding how to process data received from its associated data source 240. As an example, a user may input the desired output format and desired destination addresses into intermediate device 250₁ instructing the data distribution device 205 how to process and distribute data received from its associated data source device 240₃. The data distribution device 205 would then receive the data from the data source device 240₃ and its associated instruction regarding the desired output format and the desired destination addresses, process the data in response to the associated instruction, and send the processed data to the desired destination addresses in response to the associated instruction. While the associated instruction is preferably sent to the data distribution device concurrently with the data, it may be sent prior to or subsequent to the data, provided there is some identifier included with the data and the instruction allowing them to be associated at the data distribution device 205.

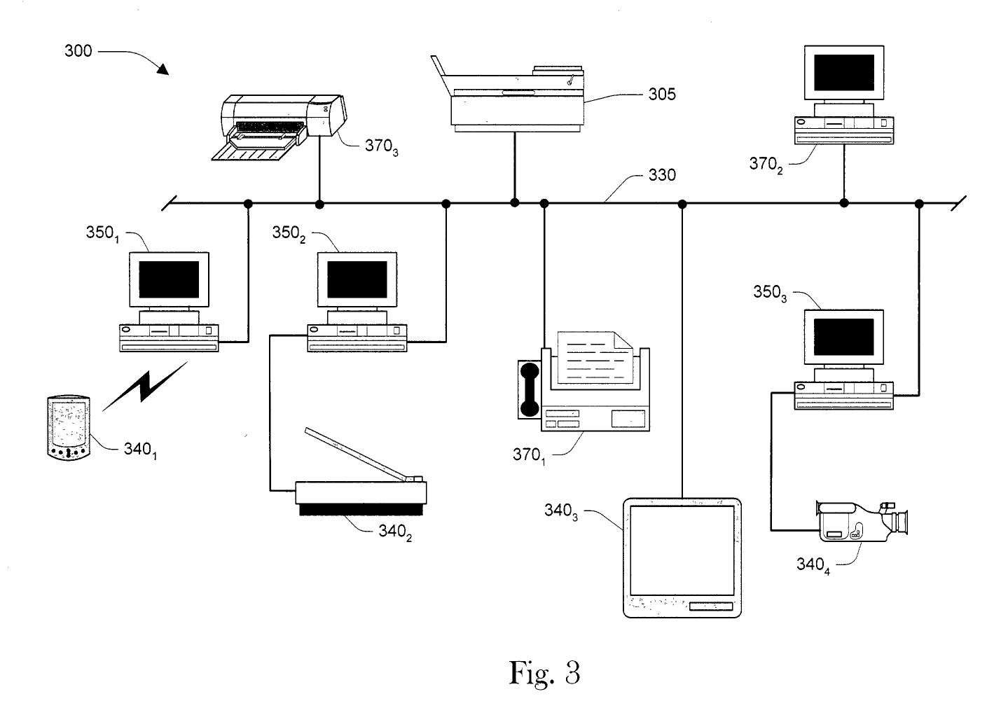

FIG. 3 is a functional schematic of another data distribution system 300 in accordance with an embodiment of the invention. Data distribution system 300 includes a data distribution device 305 in accordance with an embodiment of the invention. Data distribution device 305, for the embodiment depicted in FIG. 3, is communicatively coupled to personal computers 350₁ to 350₃. Some example external data source devices 340 communicatively coupled to the data distribution device 305 include a hand-held device 340₁, a scanner 340₂, an electronic whiteboard 340₃ and a digital camera 340₄. Other data source devices may also be in communication with the data distribution device 305, either directly or through the network 330.

As depicted in FIG. 3, data distribution device 305 is further communicatively coupled to data destination devices 370, such as facsimile machine 370₁, personal computer 370₂ and printer 370₃. Other data destination devices may also be in communication with the data distribution device 305, either directly or through the network 330. In addition, one or more of the intermediate devices 350 may also act as data destination devices 370.

Data generated at one of the source devices 340 may include more than one type of data. For example, the digital camera 340₄ may permit associating a narration with a digital photo. A user may want to forward a copy of this image data with its associated audio data to a mailing list via email or other form of electronic messaging. The image and audio data can be transmitted to the personal computer 350₃ for sending to the data distribution device 305 along with an instruction adapted to cause the data distribution device 305 to process and send the data to each recipient of the mailing list, such as a mail server for users of personal computers 350₁, 350₂, 350₃ or 370₂.

Data output from the data distribution device 305 may also include more than one type of data format. For example, the data source device might be the electronic whiteboard 340₃. A facilitator of a meeting could provide a distribution list to the data distribution device 305 for all data received from the whiteboard 340₃. This distribution list could be stored in the memory of the data distribution device 305 and associated with the whiteboard 340₃ such that data received from the whiteboard 340₃ would be routed, after processing, to this predefined list of destination addresses. The modes of desired distribution might include electronic messaging, facsimile transmission, printing and remote storage.

To continue the foregoing example, notes, drawings and action items could be kept on the whiteboard 340₃ during the meeting. Every time a copy instruction is given to the whiteboard 340₃, the whiteboard 340₃ could capture the image from its input surface and send that image data to the data distribution device 305. This image data could then be processed, packaged and sent electronically to each recipient of its associated distribution list. For email distribution, the image data might be a bitmap image file that is simply attached to the email. For facsimile transmission, the received image data could be rasterized and sent to the facsimile machine 370₁, either via the network 330 or via traditional telephonic communications. For printing, the received image data could be converted to an image page description and sent as a print job to the printer 370₃. For remote storage, the received image data could be sent unaltered or converted to a desired output format for storage on a remote device, such as the personal computer 370₂. The data distribution device 305, for some embodiments, may thus be adapted to process the received data into output formats suited for use with destination devices of various types. The selection of the output format type may be directed by a user in an instruction associated with the received data, or it may be dependent upon an identity of the data source device or an identity of the destination device.

For various embodiments, the data distribution device 305 is also a data source device having capabilities to generate data, e.g., incorporating scanning functions such as found in a typical digital sender. However, the data distribution device 305 may be devoid of data generation capabilities, relying solely on data received from external data source devices.

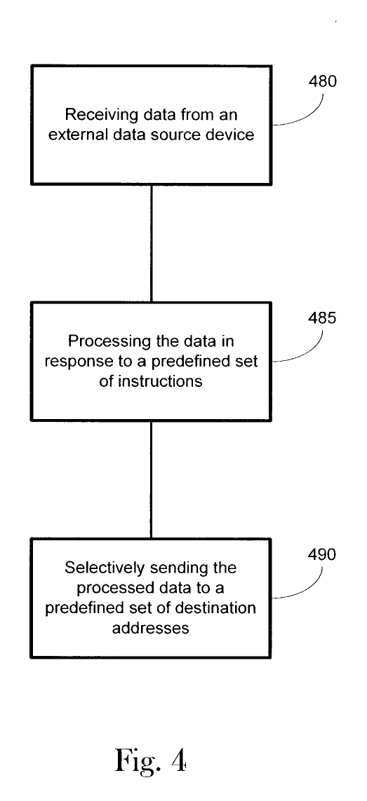

FIG. 4 is a flowchart of a method of distributing data in accordance with an embodiment of the invention. At 480, the method includes receiving data from an external data source device. The data may be received either through a direct communication link to the receiving device or through a network in communication between the data source device and the receiving device. The data may further be associated with an instruction indicative of a desired output format and/or a desired set of destination addresses to which to send the processed data.

At 485, the method further includes processing the data in response to a predefined set of processing instructions. The predefined set of processing instructions may reside entirely at the device receiving the data. For such embodiments, the receiving device would process the data in response to a set of instructions predefined by the identity of the data source device and/or the format of the received data. Alternatively, the data may be associated with one or more instructions regarding one or more desired output formats for the processed data. Such associated instructions may be as simple as an identifier designating a selection of a menu choice for the receiving device. Alternatively, the associated instructions could include complete drivers for processing the received data into the desired output format.

At 490, the method still further includes selectively sending the processed data to a predefined set of destination addresses. The predefined set of destination addresses may reside entirely at the device receiving the data. For such embodiments, the receiving device would selectively send to processed data to a set of destination addresses predefined by the identity of the data source device and/or the format of the received data. Alternatively, the data may be associated with one or more instructions regarding one or more destination addresses for the processed data. Such associated instructions may be as simple as an identifier designating a selection of a menu choice for the receiving device. Alternatively, the associated instructions could include a list of destination addresses for each type of output format.

### CONCLUSION

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

What is claimed is:

1. A data distribution device comprising:
a means for receiving data from an external data source;
a means for processing the received data in response to a predefined set of processing instructions to generate processed data of at least one format type selected from a plurality of output format types; and
a means for selectively sending the processed data to a predefined set of destination addresses.

2. The data distribution device of claim 1, further comprising wherein the predefined set of processing instructions is dependent on an identity of the external data source, a format type of the received data, or an instruction associated with the received data.

3. The data distribution device of claim 1, further comprising wherein the predefined set of destination addresses is dependent on an identity of the external data source, a format type of the received data, a format type of the processed data or an instruction associated with the received data.

4. The data distribution device of claim 1, wherein the means for selectively sending the processed data to a predefined set of destination addresses further comprises means for selectively sending processed data of a first format type to a first set of destination addresses and sending processed data of a second format type to a second set of destination addresses.

5. The data distribution device of claim 1, further comprising:
a means for generating data;
wherein the means for processing is further adapted to process the generated data for output to one or more destination addresses.

6. A data distribution device comprising:
a memory; and
a processor adapted to receive data from an external data source, the processor adapted to process the data into a formatted data file in response to a predefined set of processing instructions contained in the memory, and the processor adapted to transmit the formatted data file to one or more predefined destination addresses;
wherein a format type of the formatted data file is selectable from a plurality of format types.

7. The data distribution device of claim 6, wherein the predefined set of processing instructions is selected, at least in part, in response to an identity of the external data source from which data is received.

8. The data distribution device of claim 6, wherein the predefined set of processing instructions is selected, at least in part, in response to a format type of the received data and a desired format type of the processed data.

9. The data distribution device of claim 6, wherein the predefined set of processing instructions is selected, at least in part, in response to an instruction associated with the received data.

10. The data distribution device of claim 6, wherein the predefined set of processing instructions is received concurrently with the received data.

11. The data distribution device of claim 6, wherein the predefined set of destination addresses is associated with an identity of the external data source from which data is received.

12. The data distribution device of claim 6, wherein the predefined set of destination addresses is selected in response to an instruction associated with the received data.

13. The data distribution device of claim 6, wherein the predefined set of destination addresses is received concurrently with the received data.

14. A data distribution device comprising:
a memory; and
a processor adapted to receive data and a set of destination addresses from an external data source, the processor adapted to process the received data into one or more formatted data files in response to a predefined set of processing instructions contained in the memory, and the processor adapted to transmit one of the formatted data files to each of the destination addresses;
wherein the predefined set of processing instructions is selected in response to an instruction associated with the received data.

15. The data distribution device of claim 14, wherein the predefined set of destination addresses is received concurrently with the received data.

16. The data distribution device of claim 14, wherein the instruction associated with the received data is indicative of one or more desired output formats for the formatted data files.

17. The data distribution device of claim 14, wherein the predefined set of processing instructions are further adapted to cause the processor to process the received data into formatted data files having more than one output format type.

18. The data distribution device of claim 17, wherein the predefined set of processing instructions are further adapted to cause the processor to process the received data into formatted data files having different output format types for destination addresses having different destination types.

19. The data distribution device of claim 18, wherein the output format types are selected in response to an identity of at least one device selected from the group consisting of an identity of the external source device and an identity of a device associated with the destination address.

20. A method for distributing data, comprising:
receiving data from an external data source device;
processing the received data in response to a predefined set of processing instructions; and
selectively sending the processed data to a predefined set of destination addresses.

21. The method of claim 20, wherein selectively sending the processed data further comprises selectively sending the processed data using a mode selected from a plurality of distribution modes.

22. The method of claim 20, wherein selectively sending the processed data further comprises selectively sending the processed data using at least two modes of distribution.

23. The method of claim 21, wherein the modes of distribution are selected from the group consisting of electronic messaging, facsimile transmission, printing and remote storage.

24. The method of claim 21, wherein receiving data further comprises receiving data of a type selected from the group consisting of image data, video data and audio data.

25. The method of claim 24, wherein receiving data further comprises receiving data of a first type associated with data of a second type.

26. The method of claim 20, wherein receiving data from an external data source device further comprises receiving data from an external data source device through an intermediate device.

27. The method of claim 20, further comprising:
selecting the predefined set of processing instructions in response to an identity of the external source device.

28. The method of claim 20, further comprising:
selecting the predefined set of processing instructions in response to a format type of the received data.

29. The method of claim 20, further comprising:
selecting the predefined set of processing instructions in response to an instruction associated with the received data.

30. The method of claim 20, further comprising:
selecting the predefined set of destination addresses in response to an identity of the external source device.

31. The method of claim 20, further comprising:
selecting the predefined set of destination addresses in response to a format type of the received data and a format type of the processed data.

32. The method of claim 20, further comprising:
selecting the predefined set of destination addresses in response to an instruction associated with the received data.

33. A method for distributing data, comprising:
receiving data from an external data source device;
selecting a predefined set of processing instructions in response to an instruction associated with the received data, wherein the instruction is indicative of one or more desired output format types;
processing the received data in response to the predefined set of processing instructions, thereby generating a formatted data file for each of the desired output format types; and
selectively sending the formatted data files to a predefined set of destination addresses.

34. The method of claim 33, wherein selectively sending the processed data further comprises selectively sending the processed data using a first distribution mode for a first output format type and using a second distribution mode for formatted data files of a second output format type.

35. The method of claim 34, wherein the distribution modes are selected from the group consisting of electronic messaging, facsimile transmission, printing and remote storage.

36. The method of claim 33, wherein receiving data further comprises receiving data of a type selected from the group consisting of image data, video data and audio data.

37. The method of claim 36, wherein receiving data further comprises receiving image data associated with audio data.

38. The method of claim 33, further comprising:
selecting the predefined set of destination addresses in response to an identity of the external source device.

39. The method of claim 33, further comprising:
selecting the predefined set of destination addresses in response to an instruction associated with the received data.

40. A computer-usable media containing computer-readable instructions adapted to cause a processor to perform a method, the method comprising:
processing data received by the processor from an external source device using a predefined set of processing instructions, wherein the predefined set of processing instructions is selected in response to at least one of an identity of the external source device, a format type of the received data and an instruction associated with the received data; and
selectively sending the processed data to a predefined set of destination addresses.

41. The computer-usable media of claim 40, wherein, in the method, selectively sending the processed data further comprises selectively sending the processed data using a mode selected from a plurality of distribution modes.

42. The computer-usable media of claim 41, wherein, in the method, the modes of distribution are selected from the group consisting of electronic messaging, facsimile transmission, printing and remote storage.

43. The computer-usable media of claim 40, wherein, in the method, selectively sending the processed data further comprises selectively sending the processed data using at least two modes of distribution.

44. The computer-usable media of claim 40, wherein, in the method, processing data received by the processor further comprises processing data of at least one type selected from the group consisting of image data, video data and audio data.

45. The computer-usable media of claim 40, further comprising:
selecting the predefined set of destination addresses in response to at least one of an identity of the external source device, a format type of the received data, a format type of the processed data and an instruction associated with the received data.

46. A computer-usable media containing computer-readable instructions adapted to cause a processor to perform a method, the method comprising:
selecting a predefined set of processing instructions in response to an instruction associated with data received by the processor from an external source device, wherein the instruction is indicative of one or more desired output format types;
processing the received data in response to the predefined set of processing instructions, thereby generating a formatted data file for each of the desired output format types; and
selectively sending the formatted data files to a predefined set of destination addresses.

47. The computer-usable media of claim 46, wherein, in the method, selectively sending the processed data further comprises selectively sending the processed data using a first distribution mode for a first output format type and using a second distribution mode for formatted data files of a second output format type.

48. The computer-usable media of claim 47, wherein, in the method, the distribution modes are selected from the group consisting of electronic messaging, facsimile transmission, printing and remote storage.

49. The computer-usable media of claim 46, wherein, in the method, the received data comprises at least one of image data, video data and audio data.

50. The computer-usable media of claim 49, wherein, in the method, received data further comprises image data associated with audio data.

51. The computer-usable media of claim 46, wherein the method further comprises:
selecting the predefined set of destination addresses in response to at least one of an identity of the external source device and an instruction associated with the received data.
